(19) United States
(12) Patent Application Publication
(10) Pub. No.: US 2003/0109944 A1
(43) Pub. Date: Jun. 12, 2003

(54) Method and system for creating electronic music file based on codes inputted by end user

(76) Inventors: Peter B. Ritz, Meadowbrook, PA (US); Anna M. Spraycar, Philadelphia, PA (US); Matthew M. Foroughi, Blue Bell, PA (US)

Correspondence Address: Daniel H. Gowb, 1701 Market Street, Philadelphia, PA, 19103, US

(21) Appl. No.: 10/004,409

(22) Filed: Dec. 6, 2001

(51) Int. Cl. G06F 17/00

(52) U.S. Cl. 700/94

(57) ABSTRACT

An electronic file that includes an end-user customized selection of audio tracks is created. A plurality of end users remotely access a network having at least a hub site. Code information corresponding to codes that identify a medium is received at the hub site. The medium includes audio tracks. Based on the code information, audio track information corresponding to the audio tracks is retrieved from a database. The audio track information is presented to the end user. A selection of at least one of the first audio tracks is received from the end user. The electronic file is created based on the selection.

### FIELD OF THE INVENTION

The present invention relates to creating an electronic file containing musical tracks for an end user based on code information provided by the end-user.

### BACKGROUND OF THE INVENTION

Consumers frequently purchase a compact disc (CD) simply to enable the consumer to listen to one or two favorite songs. Such users may be unfamiliar with the other songs, or they might not like the other songs, but their only choice is to purchase the CD. Currently, users may download individual songs with known titles to their computers from the Internet upon obtaining a subscription from a provider and paying a fee. However, unless such users have the hardware capability to transfer the songs to a transportable medium, they may then only listen to the songs on their computer. Many consumers, listen to a broadcast medium such as the radio or television to hear his or her favorite songs. In that circumstance, it is often difficult to identify the artist or even the name of the song. This makes identifying the favorite songs for purchase difficult.

Bar code scanning technology has been in use for quite some time. Bar codes appear on most items encountered by consumers every day. These items include, in particular, compact discs and other media upon which music is recorded. As bar codes have become a common and familiar part of the consumer experience, so has the use of web services and applications. It would be beneficial to combine the bar code scanning and other coding technology and web service application technology (in particular, as it relates to music applications) in order to create media upon which a customized selection of audio tracks are recorded.

### SUMMARY OF THE INVENTION

The present invention is directed to a system and method for creating an electronic file comprising an end-user-customized selection of audio tracks. A plurality of end users remotely access a network having at least a hub site. Code information corresponding to one or more codes that identify a medium is received at the hub site. The medium includes one or more first audio tracks. Based on the code information, first audio track information corresponding to the one or more first audio tracks is retrieved from a first database. The first audio track information is presented to the end user. A selection comprising at least one of the first audio tracks is received from the end user. The electronic file is created based on the selection.

### BRIEF DESCRIPTION OF THE FIGURES

FIG. 1 illustrates a preferred embodiment of a system for carrying out the methods of the present invention;

FIG. 2 illustrates an exemplary offer that may be made to a user to register for the service carried out by the inventive system and method;

FIG. 3 illustrates an exemplary screen listing an end user's scan/code input history;

FIG. 4 illustrates two exemplary screens presenting to an end user the time/date information entered by the user, radio stations to be selected by the user and songs associated with the time/date information and radio station;

FIG. 5 illustrates an exemplary screen that may be presented to a user indicating potential songs from which the user may chose to create the customized audio recording medium;

FIG. 6 illustrates an exemplary screen that allows a user to create a customized CD jacket;

FIG. 7 illustrates an exemplary data structure that may be used to design a database employed in a preferred embodiment of a system of the present invention;

FIG. 8 illustrates an exemplary data structure that may be used to design a database employed in a preferred embodiment of a system of the present invention; and

FIG. 9 illustrates a method of creating an electronic file comprising one or more audio tracks in accordance with a preferred embodiment of the present invention.

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numbers will be used throughout the drawings to refer to the same or like parts.

The present invention enables a consumer to arrange for the creation of an end-user customized audio compilation on a recording medium (e.g., a compilation of musical tracks on a CD). In accordance with the present invention, the musical tracks may be selected from a commercial recording medium (e.g. a compact disk or cassette), or other medium upon which musical tracks are recorded, or they may be selected from a broadcast (e.g. radio or television). Where the selection is made from the commercial recording medium, the consumer obtains a code (such as a UPC code located on a CD jewel box) and submits the code to a service provider that processes the code and returns to the user information indicative of audio tracks recorded on the recording medium. Where the selection is made from a broadcast, the consumer obtains information representing at least a time and date that a song was broadcasted (and, in some cases, information indicating the broadcasting station) and submits that information to the service provider that processes the code and returns to the user information relating to the song broadcasted.

Consumers may obtain codes and other information and communicate this information to the service provider using any number of devices which will be known to those skilled in the art and are within the scope of the present invention. For example, the codes may be obtained using portable wireless scanners, or scanners tethered to a personal computer. The codes may also be entered manually into a device such as a cellular telephone or remote control unit. The codes may then be communicated to the service provider (immediately upon input or at a later more convenient time) using any Internet-enabled device. Once the codes are obtained and the user has communicated the codes to the service provider, the user may then interact with the provider to create a customized mix of audio tracks. The service provider may then record the selected tracks, for example, on a CD, customize the compact disk package and ship the packaged disk to the consumer. Where the user has the hardware capability to record the audio compilation on a transportable medium, such as a compact disk, he may interact with the service provided to do so himself.

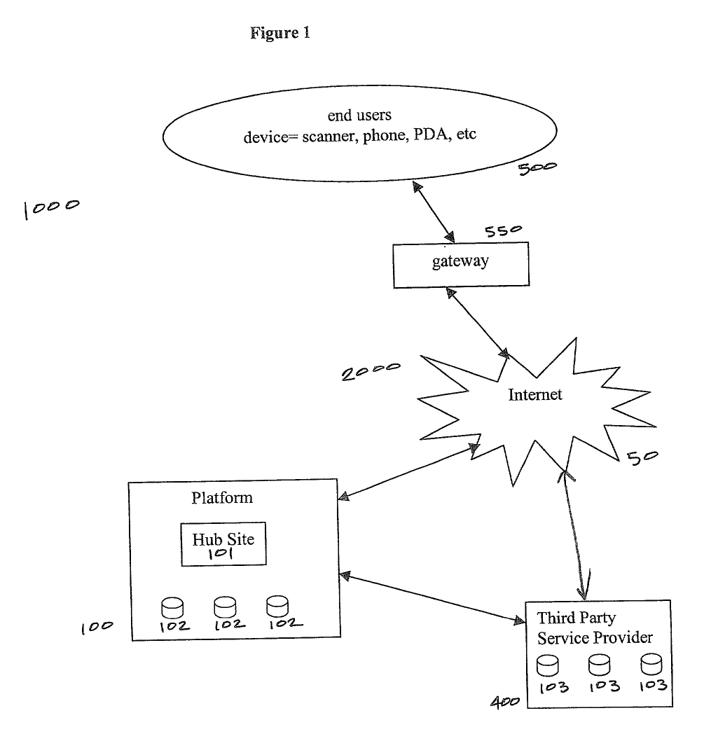

FIG. 1 illustrates a preferred embodiment of a system 1000 for carrying out the methods of the present invention. System 1000 includes a plurality of end users 500, each with a device (e.g., scanning device, a telephone, cellular telephone, wireless or other personal digital assistant, or TV remote control with a time/date stamp feature and the ability to connect to an Internet enabled device) that allows the end user 500 to scan, capture or otherwise input codes or other information (e.g., time date information). System 1000 also includes a platform 100, which is accessible to the end-users through a hub site 101 supported by platform 100. In the preferred embodiment, platform 100 is maintained and used by the service provider to, among other things, receive and store codes, supply the end user 500 with information associated with the codes (i.e. musical track information), and process end user orders for customized audio recording media. In order to store and process, for example, codes and audio track information associated with the codes, platform 100 includes one or more databases 102. In some embodiments of the present invention, the service provider may engage a third party service provider 400, which maintains one or more databases 103, to perform one or more of the described functions of platform 100, in whole or in part. Thus, for example, third party service provider 400 may be a primary or secondary source of audio tracks stored in one or more databases 103. Similarly, third party service provider 400 may receive the end user's selection of audio tracks from platform 100 and perform the service of creating the customized audio recording medium (e.g., the customized CD). Accordingly, platform 100 may be a conduit through which end users 500 send and receive information to and from third party service provider 400.

End users 500, platform 100 and the third party service provider 400 may connect to each other through a variety of different types of links to form a network 2000. For example, end users 500 may connect to platform 100 through the Internet 50, as may platform 100 to third party service provider 400. Depending on the device used by end user 500, the communication from end user 500 may be routed through one or more gateways 550. In other embodiments, alternate configurations of the connections among end users 500, platform 100 and third party service providers 400 are possible, will be known to those skilled in the art, and are within the scope of the present invention. In some embodiments, one or more of the links between these various entities is wireless.

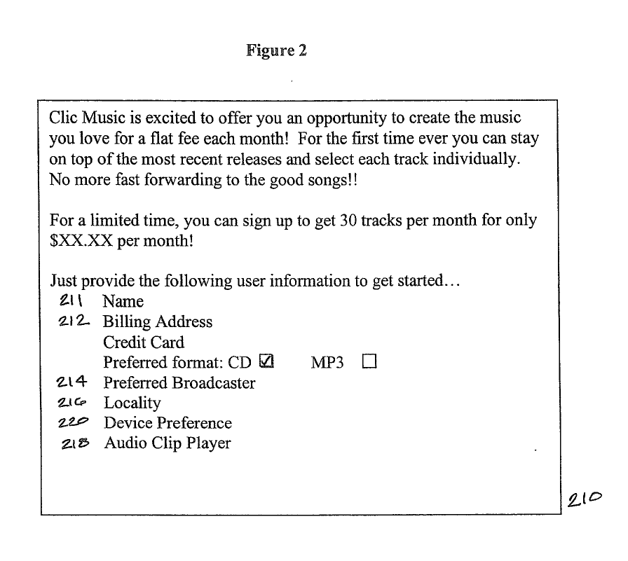

The relationship of end users 500 with the service provider/platform 100 may begin with a registration process, in some embodiments. End-users 500 may register with platform 100 through hub site 101. For example, with reference to FIG. 2, an end user may be presented with an offer 210 (e.g., sent via electronic mail or presented on a web page via a pop-up window or other advertisement) to subscribe to the service. Registration with the service may include, among other things, providing end user identification information 211 and billing information 212, setting a preferred broadcaster 214 (e.g. a favorite radio or TV station), providing information that indicates a usual locality 216 (e.g. a zip code), indicating a preferred type of media player 215 (e.g. CD or .mp3), indicating a preferred type of audio clip player 218 (e.g. RealPlayer), and/or indicating a preferred user device 220. End user 500 may be required to purchase a subscription for the inventive service (e.g. $XX.XX per a certain number of tracks selected per month).

Once end user 500 registers with platform 100 (in embodiments where registration is accepted), end user 500 may then begin the process of identifying audio tracks in accordance with the present invention. In one preferred embodiment, the end user 500 begins by procuring codes that are indicative of audio tracks of interest to the user. For example, end user 500 may obtain a UPC code from a commercial compact disk cover, a cassette tape, or other commercial audio recording medium. This code may be, for example, entered manually into a device or scanned using a portable bar-code scanner. In another preferred embodiment, the code is a series of numbers representing a time and date that a song was heard on a radio or television station (e.g. “084510222001” representing 8:45 am on Oct. 22, 2001). This code may, again, be entered manually into a device or may be captured by a device with a time/date stamp. The user may communicate the code to platform 100 in a number of different ways. For example, codes captured on devices (either through manual entry, time/date stamp or scanning, for example) may be uploaded to platform 100 using hub site 101 or sent directly to platform 100 upon capture using an Internet connection. In another example, codes may be communicated to platform 100 by speaking the code into a telephone or by entering the code using the telephone key pad.

Thus, in one example, a consumer, while browsing in a store, scans the UPC code on the back of several CD jewel boxes. The codes are then uploaded to platform 100 via hub site 101 via a workstation connected to the Internet. The codes may be uploaded automatically upon scanning if the scanner is an Internet-connected device. The codes may also be uploaded automatically upon synching a code storage device with an device connected to the Internet upon navigation to hub site 101. Regardless of the type of upload procedure, the uploaded codes are stored, in the preferred embodiment, in platform 100. In another example, a consumer may wish to identify one or more songs that are broadcast over, for example, a radio or a television. The user activates the time stamp feature of a device while listening to each song during the broadcast, thereby recording the time and date for each. The time/date records are then uploaded (in any of the manners described with respect to uploading codes) by the user to platform 100 via hub site 101 and stored in platform 100.

It should be noted that the device used for capturing the codes or times/dates may control the user experience. For example, if the device is actively connected to the Internet during scanning or other inputting, the upload to platform 100 may be automatic. If the device is not a connected device, the codes may be stored on the device for an extended period until the user has the opportunity to upload the codes. All such embodiments are within the scope of the present invention.

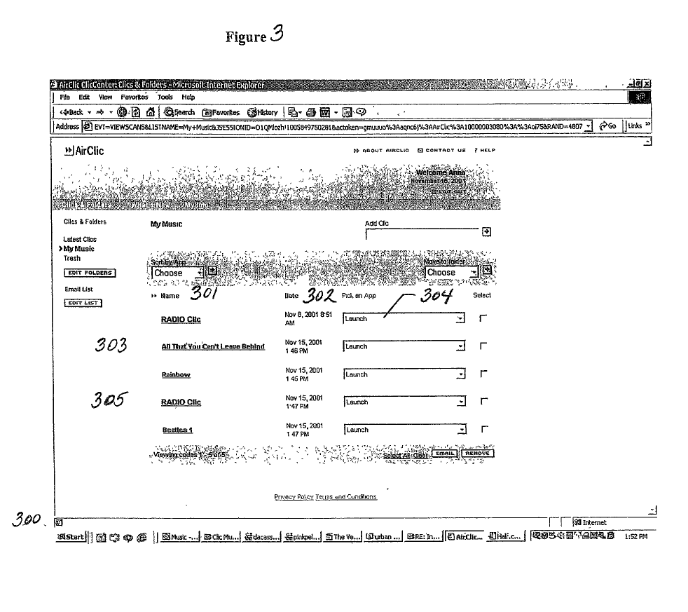

In the preferred embodiment, the codes (for example, UPC code on a CD jewel case) are resolved automatically upon uploading, if possible. Thus, with reference to FIG. 3, screen 300 displays a list, in column 301, of some names of CDs associated with codes inputted by a user. For example, title 303 represents the title of a CD scanned by a user. A date and time 302, representing the date and time the codes were scanned, may also be shown. File 305, for example, represents a file in which the time and date of a radio broadcast was recorded by the end user. For each such file, the user may then select and launch an application (e.g. customized creation of the audio recording medium) to process the codes using application dialog box 304.

Once the code is uploaded to platform 100, and processed by the application selected in application dialog box 304, the user may be presented with a number of different types of menus, lists, and/or options. The particular presentation the user experiences may be largely determined by such factors as the registration information entered by the user, the nature of the code entered, and the device used to enter the code.

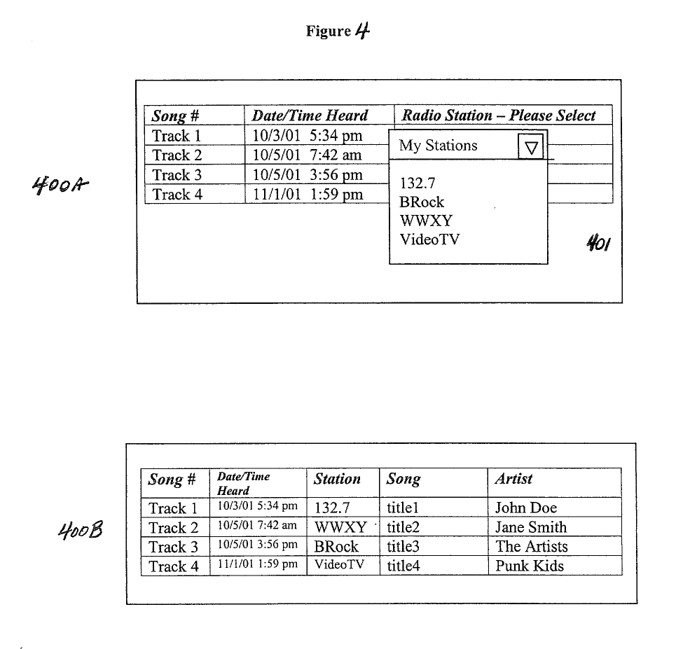

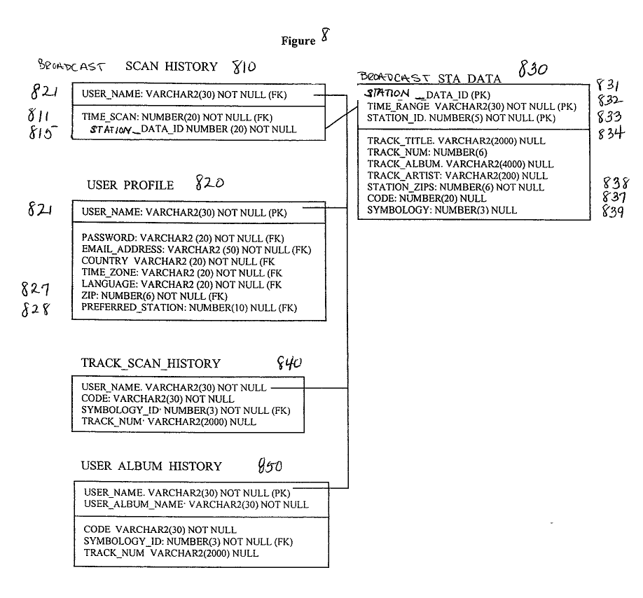

FIG. 4 illustrates an exemplary presentation made to a user. In this presentation, a table is presented to an end user who registered with platform 100 and indicated four (4) favorite broadcast stations (radio stations 132.7, B Rock, and WWXY; and TV station VideoTV). This particular end user has communicated four codes to platform 100 representing three songs that the end user heard being broadcast on the radio and one song that the end user heard during a television broadcast of a music video. For each song, the end user in this example recorded the time and date of the broadcast. The user is presented with table 400A, which indicates that four songs with as yet unknown titles were selected at four different dates and times. From a pull down menu 401, the user in this example manually associates the four songs with a broadcaster. After the user identifies the station for each time stamp, he is presented with song titles and artists as illustrated in table 400B. The system includes at least one database (portions of which are described below with reference to FIG. 8) that includes programming schedules for different broadcast stations that allow the system to associate a song title with a station and a time stamp. Where the time selected refers to the hour and minute of a time of day, there may be more than one song broadcast on a given station during the minute indicated. For example, during the one minute period identified as 3:56 pm there may be a first song that ends at 3:56:10 and a second song that begins at 3:56:12. In that circumstance, all the songs that are broadcast during at least a portion of the time indicated may be displayed for the end-user to select. Other embodiments may incorporate time periods with greater or lesser precision, thereby affecting the number of songs presented to the user. All such embodiments are within the scope of the present invention.

In another embodiment, the end user may have indicated a zip code with platform 100 upon registration. In this embodiment, the pull down menu 401 might contain broadcast stations associated with the zip code entered.

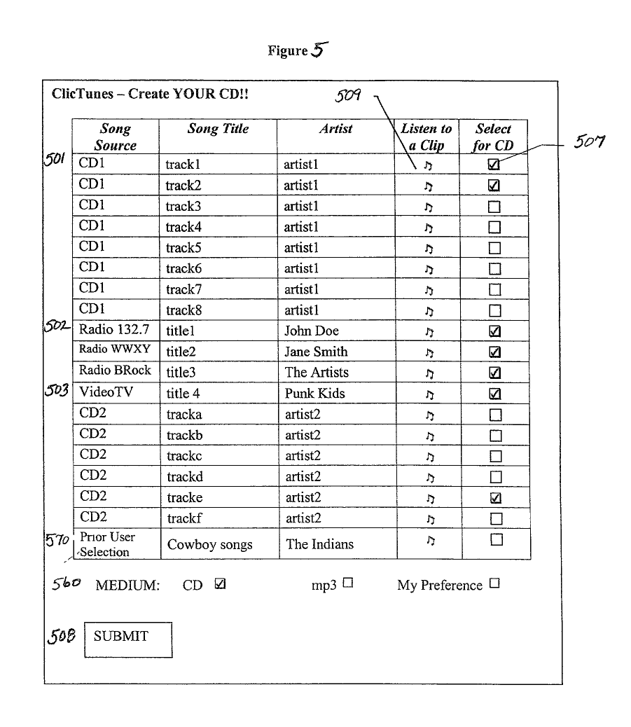

FIG. 5 illustrates an exemplary screen 500 that may be presented to a user who has communicated codes to platform 100 representing specific CDs (e.g. UPC codes) and who has communicated time/date stamps, radio station information, and TV station information. All of the song titles associated with the CDs (e.g., song source 501) as well as with the time/date stamps and radio and TV stations (e.g. song sources 502 and 503) are presented to the user on screen 500. Further, in some embodiments, additional songs may be presented to the user based on selections the user has made in the past. For example, song source 570 (a song by a country and western artist) may be presented to the user based on the user's prior selection of country and western audio tracks in an earlier session.

Also illustrated in FIG. 5 is a preferred embodiment of a mechanism that permits the end user to listen to clips of each song communicated to platform 100 through codes or other information input by the end user. When an end user in communication with platform 100 using a PC or other device (such as a wireless device) selects the music note icon 509, an audio player such as Windows Media or RealPlayer (or any other audio player known in the art) is activated. Where the end user has not indicated a preferred audio player upon registration, a prompt may be activated for the user to select his preferred player upon the end user clicking on music note icon 509.

The user may select the songs it wishes to include on the customized audio recording medium by checking one or more boxes in selection column 507. The user may also select, using one of the medium buttons 560, the type of medium upon which he wishes to load the customized selection (or the user may rely on a preferred medium indicated upon registration). For example, the user may wish to have the songs recorded on a CD. In another example, the user may wish to have the songs stored in a file (for example, compressed in .mp3 format or in .wav format) that the end user may then maintain on his PC. Other recording and storing options will be known to those skilled in the art and are within the scope of the present invention.

Upon making the selection and clicking on submit button 508, the user's selection is then transmitted to the service provider at platform 100 and maintained in an electronic file. The service provider (either itself or through a third party service provider 400) fulfills the end user's order either by burning a CD with the user's selected songs, by storing the songs in a file (e.g., in compressed format), or otherwise processing the selection in accordance with the user's selection.

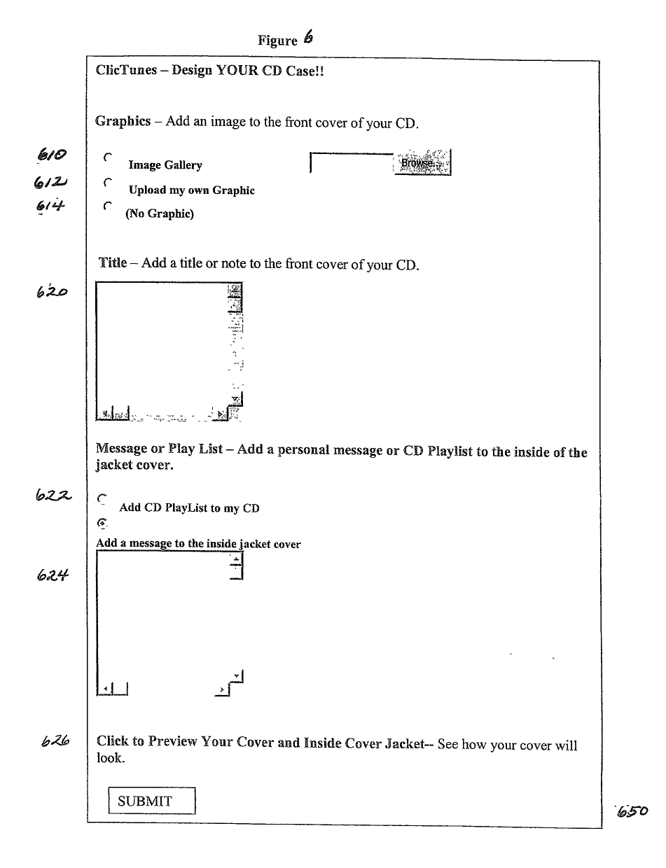

End users who order CDs or other tangible audio recording media may wish to customize the jewel case jacket or cover for the media. FIG. 6 illustrates an exemplary screen 650 that may be presented to the user and allow the user to make custom design selections for, in this case, a CD. For example, the end user may desire a graphic illustration to appear on the jacket. The end user may select images from an image gallery stored on database 102 or 103 by selecting the image gallery button 610. Alternatively, the end user may select an image that is stored on the user's device by selecting the end user graphic button 612. After making a button selection, the end user may click on the browse button 616 and be presented with a menu of images from which to choose. An end user may choose not to insert an image by selecting no graphic button 614. An end user may add formatted text to the cover by typing the text into dialog box 620. If a play list is desired, the end user may select the play list button 622. The end user may also add a message to the inside jacket cover by typing the text into dialog box 624. The end user may preview the CD case design by clicking on preview button 626.

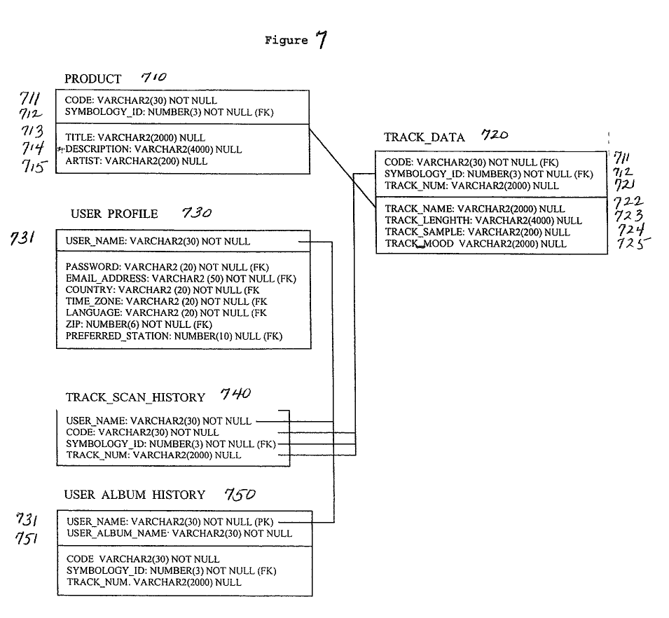

Referring now to FIG. 7, an exemplary data structure for a portion of database 102 (or database 103) is illustrated. In particular, linking a code printed on a medium on which musical tracks are recorded to information regarding the musical tracks stored on that medium may be accomplished using this data structure. Product table 710 stores product information for a given code 711 (e.g., a UPC code) and symbology 712. Such product information includes a title associated with the code 713 (e.g. an album title), a description of the product 714, and the artist associated with the recording 715. For a given code 711 and symbology 712, the audio tracks on a CD can be identified from track data table 720. For each track number 721, track data table 720 includes the name 722 of each musical track on the recording medium, as well as the length 723 of each track. In addition, data used for playing an audio clip of each track is stored in track data table 720 as track sample 724.

Where registration information is collected from the user, it may be stored in user profile table 730. For a given user name 731, various user data can be identified such as user passwords, email address, country, time zone, language, zip code, and preferred stations.

Referring still to FIG. 7, the presentation to a user of a musical track based on a user's prior musical track selections may be accomplished using this data structure. In particular, track mood key 725 identifies the classification of the track and can be used as the key to search for other similar tracks. Track mood key 725 can be created in numerous ways including identifying key acoustic attributes of a track or using user ratings (e.g. “Users who liked track A, also liked tracks BG”).

Track scan history table 740 stores, for each user name 731, the user's scan history including each track number 721 selected (from track data table 720) for a given code and symbology. Where a user has created a compilation of tracks, the compilation may be stored in user album history table 750. User album history table thus stores the name 751 of the compilation identifying a number of track numbers 721 each associated with a given code 711 and symbology 712.

Referring now to FIG. 8, an exemplary data structure for another portion of database 102 (or database 103) is illustrated. In particular, the identification of a musical track based radio or television station information and/or on time/date information may be accomplished using this data structure. For each user, user profile information, including user name 821 and the user's preferred station 828 (if any) is stored in user profile table 820. Referring to broadcast scan history table 810, for a given time scan 811 inputted by the user and preferred station 828 from user profile table 820, a track title 834 is identified from broadcast station data table 830 (using time range 832 and station identification 833 of broadcast station data table 830). Once a track title 834 is identified, the recording medium upon which the track is recorded can be identified using the code 837 and symbology 839 in broadcast station data table 830.

In an embodiment where the user has not necessarily indicated his preferred station 828, but has registered a zip code with platform 100, the zip code will be saved in the zip field 827 of user profile table 820. Using the zip code from zip field 827, stations associated with the registered zip code may be identified from broadcast station data table 830 from station zip field 838. The user may then be presented with the list of stations retrieved for selection. Using the station selection and a given time scan 811 from broadcast scan history table 810, the track title 834 may be identified from broadcast station data table 830. In an alternate embodiment, where the user has not either indicated his preferred radio station or entered his zip code, the user is presented with all the tracks played on all possible stations within the system for a given time scan 811. The user in this embodiment would select the track rather than the radio station. In yet another embodiment, where the user has not registered a zip code, the user could choose a zip code to initiate the station or track look-up feature described.

Regardless of the look-up embodiment used, once the user has communicated his selection with platform 100, each selection made by the user is saved as station data ID 831 in broadcast station data table 830.

Just as with musical track selections made from a audio recording medium described with reference to FIG. 7, musical track selections made from radio and television broadcasts are stored in track scan history table 740 and, for compilations of tracks, in user album history table 750.

Once the user has established a compilation to be recorded on a medium, such as a compact disk, the recording is created by processes that are well known in the art. For example, platform 100 may burn a compact disk or arrange to have it done by a third party. Similarly, once the user has entered information into screen 650, a customized sleeve and cover may be generated using techniques that are also well known in the art. For example, services of these types are offered by Acoustica and by Roxio.

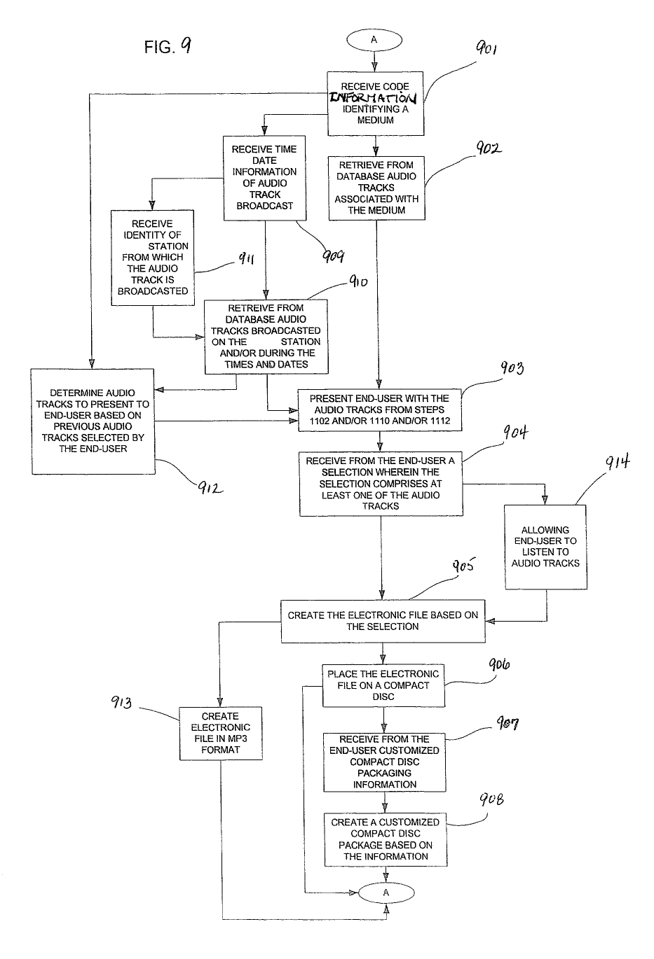

With reference to FIG. 9, a method for creating an electronic file comprising an end-user customized selection of audio tracks, in a system having a plurality of end users that remotely access a network having at least a hub site, is illustrated. In step 901, code information corresponding to one or more codes that identify a medium (e.g., compact disc, cassette tape, MP3 memory stick, etc.) is received at the hub site. The medium comprises one or more first audio tracks (e.g., music, dialogue, sound effects, etc.). In step 902, based on the code information, first audio track information (e.g., all the song titles on a CD scanned by the end user) corresponding to the one or more first audio tracks is retrieved from one or more databases (e.g., database 102 or database 103). In step 903, the end-user is presented with the first audio track information that is retrieved from the database.

In one embodiment, in addition to identifying audio tracks by submitting codes that identify a medium (e.g. a CD), time date information may be used to identify the audio tracks. In this embodiment, in step 909, time date information corresponding to broadcast times and dates of one or more broadcasted audio tracks is received at the hub site. In another embodiment, the identity of the radio station may also be provided by the end-user. In this embodiment, in step 911, the identity of the radio or television station corresponding to the broadcaster of the broadcasted audio tracks may be received in addition to the time and date information. In step 910, second audio track information (e.g., song titles) corresponding to the one or more broadcasted audio tracks are retrieved from the one or more databases (e.g., database 102 or 103). The end-user is then presented with the second audio track information in step 903.

In still another embodiment, certain audio tracks are presented to the end-user based on previous audio tracks selected by the end user. In this embodiment, in step 912, third audio track information (e.g., a song titles) is compiled based on prior selections made by the end-user. In step 903, the end user is presented with the third audio track information.

In step 904, a selection from the end user comprising at least one of the first audio tracks, broadcasted audio tracks, and third audio tracks is received. In step 905, the electronic file is created based on the selection. The electronic file may be placed on a compact disc for the end-user, in step 906. In some cases, the end-user creates the compact disc himself. In addition, the electronic file may be created in MP3 format, in step 913.

In one embodiment, the end-user is allowed to sample the audio tracks. This may occur either before making the selection or after making the selection. In this embodiment, in step 914, the end-user listens to one or more of the audio tracks. One purpose of allowing the end-user to sample the audio tracks is to encourage the end-user to make further selections.

The end-user may be presented with the option of designing customized compact disc packaging. In step 907, the customized compact disc packaging information is received from the end user. In step 908, the customized compact disc packaging is created based on the packaging information received from the end user.

Although the foregoing description is directed to the preferred embodiments of the invention, it is noted that other variations and modifications will be apparent to those skilled in the art, and may be made without departing from the spirit or scope of the invention.

What is claimed is:

1. In a system having a plurality of end users that remotely access a network having at least a hub site, a method for creating an electronic file comprising an end-user-customized selection of audio tracks, the method comprising:
receiving, at the hub site, code information corresponding to one or more codes which identify a medium, the medium comprising one or more first audio tracks;
based on the code information, retrieving from one or more databases first audio track information corresponding to the one or more first audio tracks;
presenting to the end-user the first audio track information;
receiving from the end-user a selection comprising at least one of the first audio tracks; and
creating the electronic file based on the selection.

2. The method according to claim 1 further comprising:
receiving at the hub site, time date information corresponding to broadcast times and dates of one or more broadcasted audio tracks;
retrieving from the one or more databases, second audio track information corresponding to the one or more broadcasted audio tracks; and
presenting to the end-user, the second audio track information;
wherein the selection further comprises at least one of the broadcasted audio tracks.

3. The method according to claim 2 further comprising:
receiving, at the hub site, broadcaster information corresponding to the broadcaster of the broadcasted audio tracks.

4. The method according to claim 1 further comprising:
placing the electronic file on an audio recording medium.

5. The method according to claim 2 further comprising:
placing the electronic file on an audio recording medium.

6. The method according to claims 4 or 5 wherein the audio medium is a compact disk.

7. The method according to claim 4 further comprising:
receiving from the end user end-user customized compact disc packaging information.

8. The method according to claim 5 further comprising:
receiving from the end user end-user customized compact disc packaging information.

9. The method according to claim 7 further comprising:
creating a customized compact disc package based on the packaging information.

10. The method according to claim 8 further comprising:
creating a customized compact disc package based on the packaging information.

11. The method according to claim 1 further comprising:
compiling third audio track information based upon the selection; and
presenting the end-user with the third audio track information.

12. The method according to claim 2 further comprising:
compiling third audio track information based upon the selection; and
presenting the end-user with the third audio track information.

13. The method according to claim 1 wherein the electronic file is created in accordance with an end-user subscription.

14. The method according to claim 2 wherein the electronic file is created in accordance with an end-user subscription.

15. The method according to claim 13 wherein the end-user pays a periodic fee in exchange for creation of a predetermined number of electronic files.

16. The method according to claim 14 wherein the end-user pays a periodic fee in exchange for creation of a predetermined number of electronic files.

17. The method according to claim 1 wherein at least one of the first audio tracks is in a compressed format.

18. The method according to claim 3 wherein at least one of the first audio tracks or the broadcasted audio tracks is in a compressed format.

19. The method according to claims 17 or 18 wherein the compressed format is .mp3.

20. The method according to claim 1 further comprising:
allowing the end-user to listen to at least a portion of at least one of the first audio tracks.

21. The method according to claim 1 further comprising:
allowing the end-user to listen to at least a portion of at least one of the broadcasted audio tracks.

22. The method of claim 9 or 10 wherein the compact disc is created by the end user.

23. A system for creating an electronic file comprising an end-user-customized selection of audio tracks, the system comprising:
a network that is accessed remotely by a plurality of end users, the network comprising one or more databases that store first audio track information;
at least one hub site that receives code information corresponding to one or more codes that identify a medium, the medium comprising one or more first audio tracks; based on the code information, retrieves from the one or more databases the first audio track information corresponding to the one or more first audio tracks; presents to the end-user the first audio track information; receives from the end-user a selection comprising at least one of the first audio tracks; and creates the electronic file based on the selection.

24. The system of claim 23 wherein the one or more databases further store second audio track information and wherein the hub site further receives time date information corresponding to broadcast times and dates of one or more broadcasted audio tracks; retrieves from the one or more databases the second audio track information corresponding to the one or more broadcasted audio tracks; and presents to the end-user the second audio track information, wherein the selection further comprises at least one of the broadcasted audio tracks.
